(19) United States
(12) Patent Application Publication
(10) Pub. No.: US 2012/0097571 A1
(43) Pub. Date: Apr. 26, 2012

(54) Food Packaging System with Separable Food Utensils

(75) Inventor: Ran Lerner, New York, NY (US)

(73) Assignee: SUNCIRC, LLC, Guilford, CT (US)

(21) Appl. No.: 13/322,005

(22) PCT Filed: May 24, 2010
(86) PCT No.: PCT/US2010/035975

§ 371 Date: Nov. 22, 2011

Related U.S. Application Data
(60) Provisional application No. 61/180,447, filed on May 22, 2009.

(51) Int. Cl. A47J 43/28; B65B 1/00; A45C 11/20

(52) U.S. Cl. 206/541; 30/142; 30/150; 53/396

(57) ABSTRACT

An integrated food utensil assembly includes a utensil member with integral food utensil parts connected together along a frangible zone when connected, and separable along the frangible zone to form discrete food utensils when separated. The assembly overlies a food container. Multiple food containers could be stacked and held together. The utensil member can comprise a circular disc, the frangible zone can extend along a generally S-shaped line, and the utensil parts can have a general C-shape. One utensil part can have a working end region comprising a shallow bowl, and the other utensil part can have a working region comprising a set of tines.

### CROSS-REFERENCE TO RELATED APPLICATION

This application claims the benefit of U.S. Provisional Patent Application Ser. No. 61/180,447, filed May 22, 2009, which is hereby incorporated by reference herein.

### TECHNICAL FIELD

This invention generally relates to integrating food utensils in food packaging systems, especially of the type used for single servings of pre-packaged foods such as yogurt, ice cream, soup or fruit and, more particularly, to reducing packaging waste, weight and size, as well as increasing consumer use and acceptance of such systems.

### BACKGROUND OF THE INVENTION

As an alternative to eating at restaurants which supply food utensils with meals, or carrying food and food utensils from home, some individuals purchase and consume ready-to-eat, pre-packaged food, such as yogurt, ice cream, soup or fruit, provided in small, single-serving containers. Such foods typically require food utensils, such as a spoon, fork or knife, to eat the food. However, such utensils are often not readily available at many locations, for example, at indoor office desks or at outdoor parks. Hence, as a sales incentive and as a consumer convenience, many food producers and packaging merchandisers provide consumers with the necessary utensils.

The art has proposed providing loose utensils or, for more sanitary use, wrapping one or more of the utensils in separately sealed sanitary packages and allowing the consumers to freely take as many packages as desired. In practice, however, many consumers take more packages than the number to which they are entitled. Also, many packages often contain more utensils than the consumer actually needs. Inventorying and resupplying such packages is not only an added expense, but also, a nuisance. All of these drawbacks not only increase packaging costs, but also increase packaging waste, especially when non-biodegradable materials are employed.

The art has also proposed to place a separate utensil inside the package, thereby always achieving a direct one-to-one correspondence between the utensil and the package. However, this placement slows production lines, and often, the utensil shifts its position inside the package during shipping. Also, the utensil may be in contact with the food, and the consumer is then forced to retrieve the utensil from the food prior to eating, thereby possibly resulting in food contamination. Sometimes, the separate utensil is held on a tray by thermoforming. However, this requires excess packaging material and results in more packaging waste.

To help overcome these problems, the art has further proposed to integrate a utensil into the package itself, for example, into a lid or closure member of a food container. In one approach, as in U.S. Pat. No. 2,598,987 to Franzen, the lid can be converted into a spoon by bending side portions of the lid towards each other. Some users, however, do not know how, or do not possess the required manual dexterity, to perform such a conversion. Another approach is to connect the utensil to the lid, for example, via a living hinge or the like. In U.S. Pat. No. 6,604,646 to Torniainen et al., for example, a utensil formed by a separate head piece and handle piece is formed within a container cover for removal and assembly by a user. However, this not only increases production cost, materials and complexity, but also a relatively large amount of space is required to be occupied by each such utensil/lid construction. In addition, food packages with such utensil/lid constructions have poor stackability. Shipping costs could be greatly minimized if such food packages were more readily stackable.

There is a need, therefore, for a food packaging system for delivery of food utensils as a part of the packaging of food products requiring a utensil such as a spoon, fork or knife for immediate consumption, especially eating utensils which are made of a biodegradable composition, which have a good “mouth feel”, which are relatively sturdy, which are integral with, yet readily separable from, the part of the packaging, which reduce packaging waste, weight and size, which increase consumer use and convenience, and which enhance the stackability of such systems.

### SUMMARY DISCLOSURE OF THE INVENTION

One feature of this invention resides, briefly stated, in an integrated food utensil assembly having a utensil member, preferably molded as one piece from a biodegradable material, with integral food utensil parts that are connected together along a frangible zone when connected, and that are separable along the frangible zone to form discrete food utensils when separated. The utensil parts are preferably curved and have opposite curvatures when the utensil parts are connected. Each utensil part extends arcuately between a convexly-curved working end region and a concavely-curved handle end region. The convexly-curved working end region of each of the utensil parts is nested and received in the concavely-curved handle end region of the other of the utensil parts when the utensil parts are connected. Advantageously. the working end region can have a shallow bowl to serve as a spoon, or can have a set of tines to serve as a fork, or can have both a shallow bowl and a set of tines to serve as a spork, or can have a knife edge to serve as a knife, or can have any other configuration of an eating utensil or combination of eating utensils.

In a preferred embodiment, the utensil member is a circular disc when the utensil parts are connected, and the utensil parts are generally C-shaped. The utensil member has a predetermined thickness, and the frangible zone has a reduced thickness less than the predetermined thickness to facilitate the separation of the utensil parts. The frangible zone extends along a curvilinear path, especially a generally S-shaped line. The utensil member is entirely constituted of the utensil parts; hence, after separation, there is no packaging waste remaining from the utensil member to discard.

Another feature of this invention resides, briefly stated, in a food packaging system, which includes the aforementioned integrated food utensil assembly overlying a food container. In one embodiment, the utensil member may have a peripheral rim that extends at least partly along each utensil part, and that engages an upper lip of the food container, thereby enabling the utensil member to serve as a lid or closure for the food container.

In another embodiment, the food container may have a closure member formed with a top portion and a raised ridge elevated above the top portion, and then, the utensil member is mounted on the top portion and received within the raised ridge. The top portion is generally planar, and the utensil member preferably has a generally planar outer surface that engages the generally planar top portion of the closure member in surface area contact. Advantageously, the utensil member is a circular disc when the utensil parts are connected, and the raised ridge is circular and surrounds the disc. The raised ridge preferably has access slots through which the utensil member is accessible.

The food packaging system may include an additional food container mounted in a stack above the first-mentioned food container. Each food container has a base formed with opposite side openings. Each food container also has a closure member formed with opposite side recesses aligned with the side openings. An elongated strap extends through the aligned recesses and openings and holds the food containers together in the stack. Preferably, the closure member of each food container is formed with a top portion having an annular seat on which the base of the additional food container is supported.

Still another feature of this invention resides, briefly stated, in a method of packaging and handling food in a food container. The method is performed by overlying the container with the aforementioned utensil member having integral food utensil parts connected together along the frangible zone, by separating the utensil parts along the frangible zone to form the discrete food utensils, and by using the food utensils to handle food from the container.

By incorporating the utensils into the utensil member or container lid, the assembly, packaging system and method disclosed herein not only reduces packaging material and associated waste, weight and size in an overall attractive design, but also simplifies manufacture and filling of the containers and conveniently enables the consumers to gain ready access to, and use of, the utensils.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a top plan view of one embodiment of an integrated food utensil assembly having integral food utensil parts connected together in accordance with this invention;

FIG. 2 is top plan view of the assembly of FIG. 1 after separation of the food utensil parts;

FIG. 3 is a perspective view of the assembly of FIG. 1 mounted on a food container to comprise a food packaging system in accordance with this invention;

FIG. 4 is a perspective view of another embodiment of an integrated food utensil assembly configured as a lid closure for a food container; and

FIG. 5 is a sectional view of a stack of food packaging systems as in FIG. 3 that are held together.

### DETAILED DESCRIPTION

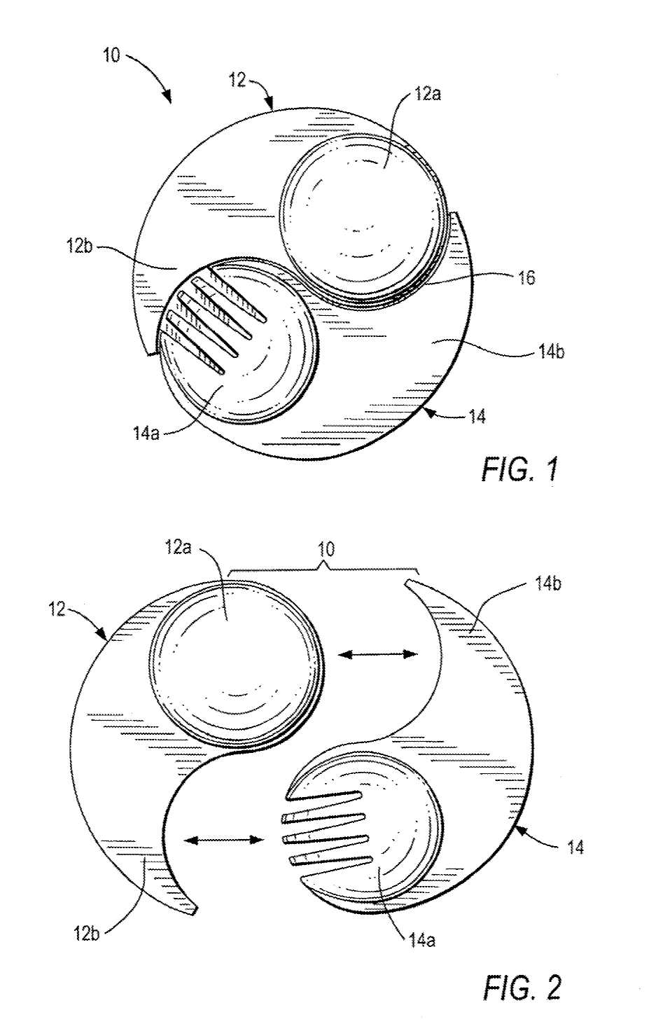

Reference numeral 10 in FIG. 1 generally identifies an integrated food utensil assembly having a utensil member, preferably molded as a single unitary piece from a biodegradable material, with integral food utensil parts 12, 14 that are connected together along a frangible zone 16 when connected, and that are separable along the frangible zone 16 to form discrete food utensils (see FIG. 2) when separated. The utensil parts 12, 14 are preferably curved and have opposite curvatures when the utensil parts 12, 14 are connected. Each utensil part 12, 14 extends arcuately between a convexly-curved working end region 12a, 14a and a concavely-curved handle end region 12b, 14b. The convexly-curved working end region 12a, 14a of each of the utensil parts is nested and received in the concavely-curved handle end region 12b, 14b of the other of the utensil parts when the utensil parts are connected (see FIG. 1). The utensil parts resemble the well known Chinese yin-yang symbol. Advantageously. the working end region 12a can have a shallow bowl to serve as a spoon, or can have a set of tines 14a to serve as a fork, or can have both a shallow bowl and a set of tines to serve as a spork 14a, or can have a knife edge to serve as a knife, or can have any other configuration of an eating utensil or combination of eating utensils. The utensils 12, 14 need not be different as shown, but could be the same utensil. More than the two illustrated utensils are also contemplated.

In a preferred embodiment, the utensil member 10 is a rigid, circular disc when the utensil parts 12, 14 are connected, and the utensil parts 12, 14 are generally C-shaped. The utensil member 10 has a predetermined thickness, and the frangible zone 16 has a reduced thickness less than the predetermined thickness to facilitate the separation of the utensil parts. The thinner the frangible zone, the more easily the utensil parts 12, 14 are detached from each other. The frangible zone 16 extends along a curvilinear path, especially a generally S-shaped line. The utensil member 10 is entirely constituted of the utensil parts; hence, after separation, there is no packaging waste remaining from the utensil member 10 to discard.

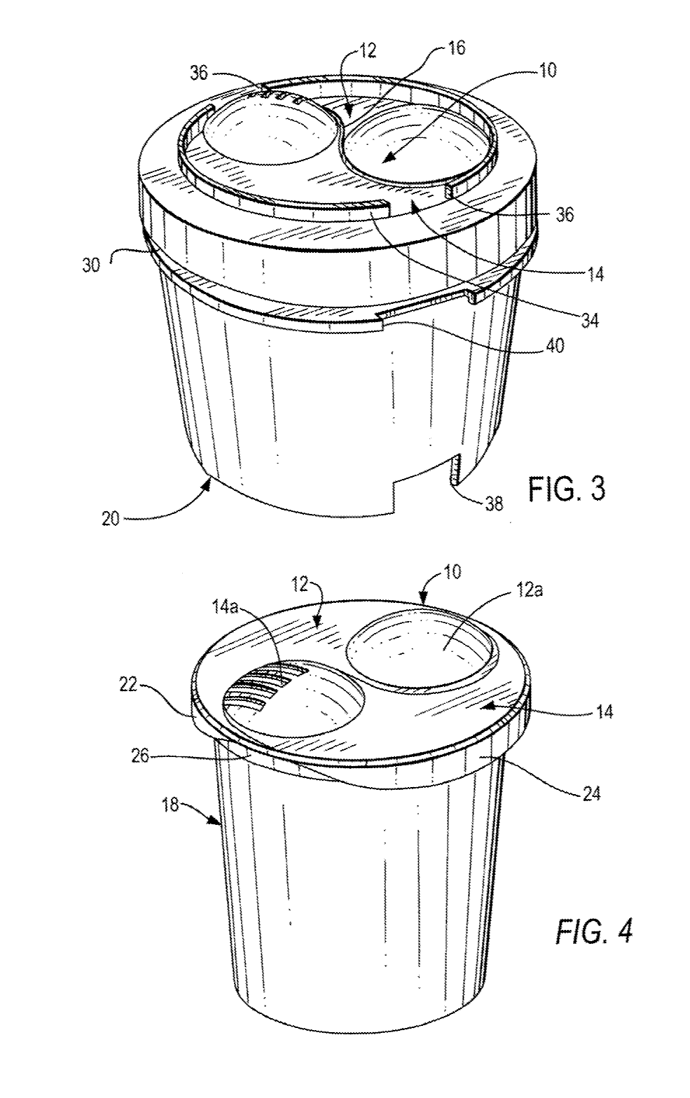

As shown in FIGS. 3 and 4, a food packaging system includes the aforementioned integrated food utensil assembly 10 overlying food containers 18 and 20. In the embodiment of FIG. 4, the utensil member has a peripheral rim 22, 24 that respectively extends at least partly along each utensil part 12, 14, and that engages an upper lip 26 of the food container 18, thereby enabling the utensil member itself to serve as a lid or closure for the food container 18. A foil layer or plastic film could lie under the utensil member for a tight seal.

In the embodiment of FIG. 3, the food container 20 has a discrete closure member 30 formed with a top portion 32 and a raised ridge 34 elevated above the top portion 32, and then, the utensil member is mounted on the top portion 32 and received within the raised ridge 34. The closure member 30 may be threaded or snapped onto the food container 20. The top portion 32 is generally planar, and the utensil member preferably has a generally planar outer surface that engages the generally planar top portion 32 of the closure member in surface area contact. Advantageously, the utensil member is a circular disc when the utensil parts 12, 14 are connected therewith, and the raised ridge 34 is circular and surrounds the disc. The raised ridge 34 preferably has access slots 36 through which the utensil member is accessible, for example, to remove the utensil member from its overlying position. In a variant, the utensil member could be positioned underneath the closure member 30.

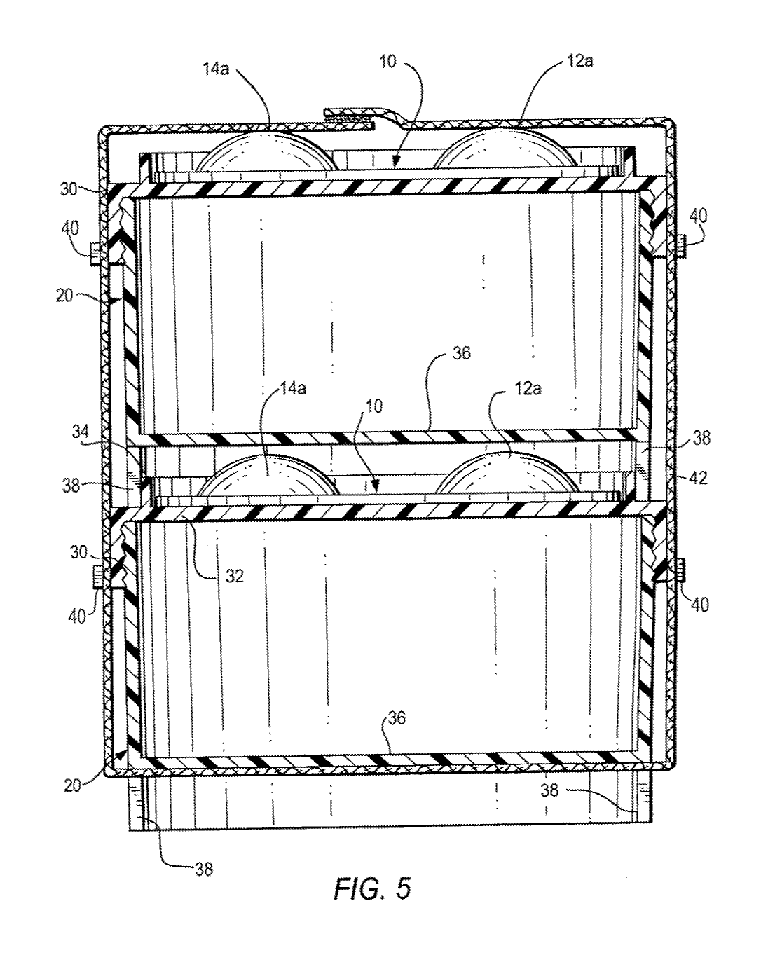

The food packaging system may include, as shown in FIG. 5, an additional food container 20 mounted in a stack above the first-mentioned food container 20. Each food container 20 has a base 36 formed with opposite side openings 38. Each food container 20 also has the aforementioned closure member 30 formed with opposite side recesses 40 aligned with the side openings 38. An elongated strap 42 extends through the aligned recesses 40 and openings 38 and holds the food containers 20 together in the stack. Preferably, the closure member 30 of each food container 20 is formed with a top portion having an annular seat on which the base 36 of the additional food container 20 is supported. The base 36 is elevated above the working end regions 12a, 14a.

It will be understood that each of the elements described above, or two or more together, also may find a useful application and use in other types of constructions differing from the types and uses described above. For example, the invention is typically used by commercial food producers and packagers for distribution and sale to food distributors and food retailers for distribution and sale to consumers. Any pre-packaged food, such as baby food, microwavable foods, defrostable foods, may benefit from this invention.

While the invention has been illustrated and described as embodied in a food packaging system with separable food utensils, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

1. An integrated food utensil assembly comprising:
a utensil member comprising at least first and second food utensil parts connected together along a frangible zone when connected, and separable along the frangible zone to form first and second discrete, separate food utensils when separated.

2. The assembly of claim 1 wherein the utensil member comprises a circular disc when the utensil parts are connected, wherein the frangible zone extends along a generally S-shaped line, and wherein each utensil part has a general C-shape when the utensil parts are separated.

3. The assembly of claim 1 wherein the utensil parts are curved and have opposite curvatures when the utensil parts are connected, wherein each utensil part is curved between a convexly-curved working end region and a concavely-curved handle end region, and wherein the convexly-curved working end region of each of the utensil parts is nested and received in the concavely-curved handle end region of the other of the utensil parts when the utensil parts are connected.

4. The assembly of claim 3 wherein the working end region of one of the utensil parts has a shallow bowl, and wherein the working end region of the other of the utensil parts has a set of tines.

5. The assembly of claim 1 wherein the utensil member has a predetermined thickness, and wherein the frangible zone has a reduced thickness less than the predetermined thickness.

6. The assembly of claim 1 wherein the utensil member has a peripheral rim that extends at least partly along each utensil part.

7. The assembly of claim 1 wherein the utensil parts constitute substantially the entirety of the utensil member when the utensil parts are connected together along the frangible zone.

8. The assembly of claim 1 wherein the discrete food utensils are each curved between a convexly-curved working end region and a concavely-curved handle end region.

9. A food packaging system comprising:
a food container; and
an integrated food utensil assembly that overlies the food container, the integrated food utensil assembly comprising a utensil member with at least first and second food utensil parts connected together along a frangible zone when connected, and separable along the frangible zone to form first and second discrete, separate food utensils when separated.

10. The food packaging system of claim 9 wherein the utensil member further comprises a peripheral rim that extends at least partly along each utensil part and that engages an upper lip of the food container.

11. The food packaging system of claim 9 wherein the food container has a closure member formed with a top portion and a raised ridge elevated above the top portion, and wherein the utensil member is mounted on the top portion and received within the raised ridge.

12. The food packaging system of claim 11 wherein the top portion is generally planar, and wherein the utensil member has a generally planar outer surface that engages the generally planar top portion of the closure member in surface area contact.

13. The food packaging system of claim 11 wherein the utensil member is a circular disc when the utensil parts are connected, and wherein the raised ridge is circular and surrounds the disc.

14. The food packaging system of claim 11 wherein the food packaging system further comprises slots in the raised ridge through which the utensil member is accessible.

15. The food packaging system of claim 9 wherein the utensil parts are curved and comprise opposite curvatures when the utensil parts are connected, wherein each utensil part is curved between a convexly-curved working end region and a concavely-curved handle end region, and wherein the convexly-curved working end region of each of the utensil parts is nested and received in the concavely-curved handle end region of the other of the utensil parts when the utensil parts are connected.

16. The food packaging system of claim 9 wherein that the food packaging system further comprises an additional food container mounted in a stack above the food container, each food container comprising a base formed with opposite side openings and a closure member formed with opposite side recesses aligned with the side openings; and an elongate strap received through the aligned recesses and openings to hold the food containers together in the stack.

17. The food packaging system of claim 16 wherein that the closure member of each food container is formed with a top portion with an annular seat on which the base of the additional food container is supported.

18. A method of packaging and handling food in a food container comprising the steps of:
overlying the container with a utensil member comprising at least first and second food utensil parts connected together along a frangible zone;
separating the utensil parts along the frangible zone to form first and second discrete, separate food utensils; and
using the food utensils to handle food from the container.

19. The method of claim 18 wherein the method further comprises configuring the frangible zone to extend along a curvilinear path, and wherein the separating step is performed by snapping the utensil parts apart along the curvilinear path.

20. The method of claim 18 wherein the method further comprises stacking an additional food container in a stack above the food container and holding the food containers together in the stack.

21. A food utensil assembly comprising:
at least first and second food utensil parts wherein the utensil parts are curved with opposite curvatures and wherein the curvature of the first utensil part can be nested with the curvature of the second utensil part to form a unitary shape.

22. The food utensil assembly of claim 21 wherein the utensil parts can be nested to form a circular disc.

23. The food utensil assembly of claim 21 wherein the utensil parts constitute substantially the entirety of the unitary shape when the utensil parts are nested.

24. The food utensil assembly of claim 21 wherein the curvatures of the utensil parts extend along generally S-shaped lines, and wherein each utensil part has a general C-shape when the utensil parts are separated.

25. The food utensil assembly of claim 21 wherein each utensil part is curved between a convexly-curved working end region and a concavely-curved handle end region, and wherein the convexly-curved working end region of each of the utensil parts can be nested and received in the concavely-curved handle end region of the other of the utensil parts.

26. The food utensil assembly of claim 25 wherein the working end region of one of the utensil parts has a shallow bowl, and wherein the working end region of the other of the utensil parts has a set of tines.

27. The food utensil assembly of claim 25 wherein the first and second food utensil parts are connected together along a frangible zone, and wherein the utensil parts are separable along the frangible zone to form the first and second discrete, separate food utensils.
